(19) United States
(12) Patent Application Publication
(10) Pub. No.: US 2024/0098231 A1
(43) Pub. Date: Mar. 21, 2024

(54) IMAGE PROCESSING DEVICE, IMAGE PROCESSING METHOD, AND COMPUTER-READABLE MEDIUM

(71) Applicant: Socionext Inc., Kanagawa (JP)

(72) Inventor: Kazuyuki OHHASHI, Yokohama (JP)

(21) Appl. No.: 18/524,843

(22) Filed: Nov. 30, 2023

Related U.S. Application Data
(63) Continuation of application No. PCT/JP2021/020918, filed on Jun. 1, 2021.

(51) Int. Cl. H04N 9/31; G06T 3/00; G06T 7/579

(52) U.S. Cl. CPC H04N 9/3179; G06T 3/005; G06T 7/579; G06T 2207/30252

(57) ABSTRACT

In one aspect, an image processing apparatus includes a determination unit and a deformation unit. The determination unit executes first distance stabilization processing of converting a measurement distance between a three-dimensional object around a moving object and the moving object into a first distance or a second distance smaller than the first distance as a stabilization distance based on the magnitude relation between the measurement distance and the first threshold. The deformation unit deforms a projection surface of a peripheral image of the moving object based on the stabilization distance.

### CROSS-REFERENCE TO RELATED APPLICATIONS

This application is a continuation of International Application No. PCT/JP2021/020918, filed on Jun. 1, 2021, the entire contents of which are incorporated herein by reference.

### FIELD

The present invention relates to an image processing apparatus, an image processing method, and an image processing program.

### BACKGROUND

A technique of generating a composite image from any viewpoint by using a projection image obtained by projecting a captured image of the periphery of a moving object onto a virtual projection surface is disclosed. Furthermore, an improved technique of deforming a projection surface in accordance with the distance from a moving object to an obstacle has also been proposed.

Conventional techniques are described in JP 2013-207637 A, JP 2014-531078 A, JP 2008-077137 A, JP 2021-027366 A, and “Environment Recognition of Mobile Robot-Map Construction and Self-Position Estimation”, Systems, control and information (Journal of The Institute of Systems, Control and Information Engineers), Vol. 60, No. 12, pp 509-514, 2016.

Unfortunately, deformation of a projection surface in accordance with the distance between a moving object and an obstacle may make a displayed image unnatural.

### SUMMARY

### Brief Description of the Drawings

FIG. 1 illustrates one example of an overall configuration of an image processing system according to a first embodiment;

FIG. 2 illustrates one example of a hardware configuration of an image processing apparatus according to the first embodiment;

FIG. 3 illustrates one example of a functional configuration of the image processing apparatus according to the first embodiment;

FIG. 4 is a schematic diagram illustrating one example of environmental map information according to the first embodiment;

FIG. 5 is an explanatory diagram illustrating one example of an asymptotic curve according to the first embodiment;

FIG. 6 is a schematic diagram illustrating one example of a reference projection surface according to the first embodiment;

FIG. 7 is a schematic diagram illustrating one example of a projection shape determined by a shape determination unit according to the first embodiment;

FIG. 8 is a schematic diagram illustrating one example of a functional configuration of a determination unit according to the first embodiment;

FIG. 9 is a plan view illustrating one example of a situation in which a moving object is parked rearward between parking lot lines on one of which a column is located;

FIG. 10 is a plan view illustrating one example of a situation in which the moving object further approaches the column as compared with that in FIG. 9 in the case where the moving object is parked rearward between the parking lot lines on one of which the column is located;

FIG. 11 illustrates one example of a temporal change in a measurement distance of a detection point of the column closest to the moving object;

FIG. 12 is a graph illustrating one example of the relation between input and output of a distance stabilization processor;

FIG. 13 illustrates one example of a temporal change in a stabilization distance obtained by first distance stabilization processing using the measurement distance of the detection point of the column in FIG. 11 as input;

FIG. 14 illustrates one example of a temporal change in a stabilization distance D obtained by the first and second pieces of distance stabilization processing using the measurement distance of the detection point of the column in FIG. 11 as input;

FIG. 15 is a flowchart illustrating one example of a flow of image processing executed by the image processing apparatus according to the first embodiment;

FIG. 16 illustrates one example of a functional configuration of an image processing apparatus according to the second embodiment; and

FIG. 17 is a flowchart illustrating one example of a flow of image processing executed by the image processing apparatus according to the second embodiment.

### DETAILED DESCRIPTION

Embodiments of an image processing apparatus, an image processing method, and an image processing program disclosed in the present application will be described in detail below with reference to the accompanying drawings. Note that the following embodiments do not limit the disclosed technique. Then, the embodiments can be appropriately combined within a range in which the processing contents do not contradict each other.

### First Embodiment

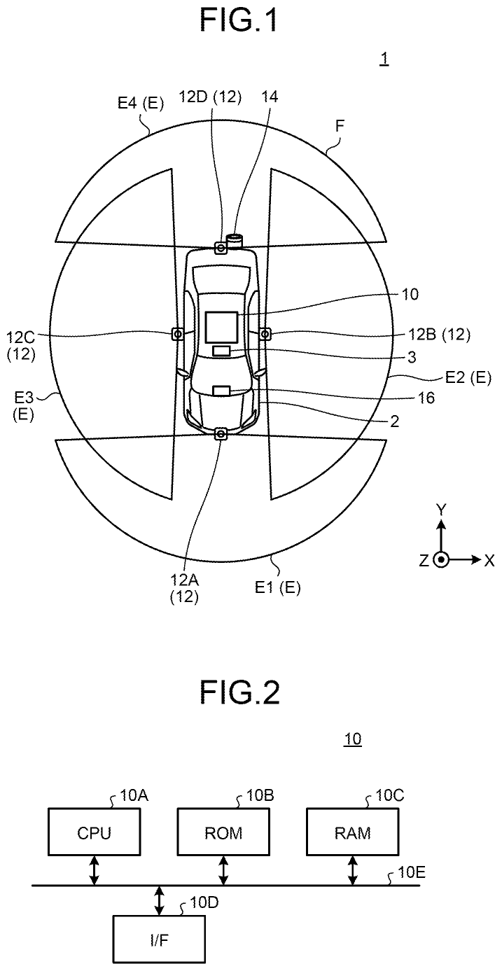

FIG. 1 illustrates one example of an overall configuration of an image processing system 1 of an embodiment. The image processing system 1 includes an image processing apparatus 10, an imager 12, a detector 14, and a display 16. The image processing apparatus 10, the imager 12, the detector 14, and the display 16 are connected so as to be able to transfer data or signals.

In the embodiment, a mode in which the image processing apparatus 10, the imager 12, the detector 14, and the display 16 are mounted on a moving object 2 will be described as one example. Note that the image processing apparatus 10 according to a first embodiment is an example in which visual simultaneous localization and mapping (SLAM) processing is used.

The moving object 2 can move. Examples of the moving object 2 include a vehicle, a flying object (manned airplane and unmanned airplane (e.g., unmanned aerial vehicle (UAV) and drone)), and a robot. Furthermore, examples of the moving object 2 include a moving object that travels through a driving operation of a person and a moving object that can automatically travel (autonomously travel) without the driving operation of a person. In the embodiment, a case where the moving object 2 is a vehicle will be described as one example. Examples of the vehicle include a two-wheeled automobile, a three-wheeled automobile, and a four-wheeled automobile. In the embodiment, a case where the vehicle is a four-wheeled automobile capable of autonomously traveling will be described as one example.

Note that the present invention is not limited to a mode in which all the image processing apparatus 10, the imager 12, the detector 14, and the display 16 are mounted on the moving object 2. The image processing apparatus 10 may be mounted on a stationary object. The stationary object is fixed to the ground. The stationary object includes an immovable object and an object stationary on the ground. Examples of the stationary object include, for example, a traffic light, a parked vehicle, and a road sign. Furthermore, the image processing apparatus 10 may be mounted on a cloud server that executes processing on a cloud.

The imager 12 images the periphery of the moving object 2, and acquires captured image data. The captured image data will be hereinafter simply referred to as a captured image. The imager 12 is, for example, a digital camera capable of capturing a moving image. Note that imaging refers to converting an image of a subject formed by an optical system such as a lens into an electric signal. The imager 12 outputs the captured image to the image processing apparatus 10. Furthermore, in the embodiment, a description will be given on the assumption that the imager 12 is a monocular fisheye camera (e.g., 195 degrees of viewing angle).

In the embodiment, a mode in which four imagers 12 (imagers 12A to 12D) are mounted on the moving object 2 will be described as one example. The plurality of imagers 12 (imagers 12A to 12D) images a subject in each of imaging regions E (imaging regions E1 to E4), and acquires captured images. Note that the plurality of imagers 12 has different imaging directions. Furthermore, the imaging directions of the plurality of imagers 12 are preliminarily adjusted such that at least a part of an imaging region E of an imager 12 overlaps with an imaging region E of an adjacent imager 12.

Furthermore, the four imagers 12A to 12D are examples, and any number of imagers 12 may be provided. For example, when the moving object 2 has a vertically long shape like a bus or a truck, the imagers 12 can be arranged one by one in front, the rear, front of the right side surface, the rear of the right side surface, front of the left side surface, and the rear of the left side surface of the moving object 2, that is, a total of six imagers 12 can be used. That is, any number of imagers 12 can be set at any arrangement position depending on the size and shape of the moving object 2. Note that processing of determining a boundary angle to be described later can be performed by providing at least two imagers 12.

The detector 14 detects position information on each of a plurality of detection points around the moving object 2. In other words, the detector 14 detects position information on each of detection points in a detection region F. The detection points indicate respective points individually observed by the detector 14 in real space. A detection point corresponds to, for example, a three-dimensional object around the moving object 2.

Position information on a detection point indicates the position of the detection point in the real space (three-dimensional space). For example, the position information on a detection point indicates the distance from the detector 14 (i.e., position of moving object 2) to the detection point and a direction of the detection point based on the detector 14. These distance and direction can be represented by, for example, position coordinates indicating a relative position of the detection point based on the detector 14, position coordinates indicating an absolute position of the detection point, or a vector.

Examples of the detector 14 include a three-dimensional (3D) scanner, a two-dimensional (2D) scanner, a distance sensor (millimeter wave radar and laser sensor), a sonar sensor that detects an object with sound waves, and an ultrasonic sensor. The laser sensor is, for example, a three-dimensional laser imaging detection and ranging (LiDAR) sensor. Furthermore, the detector 14 may be a device using a structure from motion (SfM) technique for measuring a distance from an image captured by a monocular camera. Furthermore, a plurality of imagers 12 may be used as the detector 14. Furthermore, one of the plurality of imagers 12 may be used as the detector 14.

The display 16 displays various pieces of information. Examples of the display 16 include a liquid crystal display (LCD) and an organic electro-luminescence (EL) display.

In the embodiment, the image processing apparatus 10 is communicably connected to an electronic control unit (ECU) 3 mounted on the moving object 2. The ECU 3 is a unit that electronically controls the moving object 2. In the embodiment, the image processing apparatus 10 can receive controller area network (CAN) data such as a speed and a moving direction of the moving object 2 from the ECU 3.

Next, a hardware configuration of the image processing apparatus 10 will be described.

FIG. 2 illustrates one example of the hardware configuration of the image processing apparatus 10.

The image processing apparatus 10 includes a central processing unit (CPU) 10A, a read only memory (ROM) 10B, a random access memory (RAM) 10C, and an interface (I/F) 10D. The image processing apparatus 10 is, for example, a computer. The CPU 10A, the ROM 10B, the RAM 10C, and the I/F 10D are mutually connected by a bus 10E, and have a hardware configuration using a usual computer.

The CPU 10A is an arithmetic device that controls the image processing apparatus 10. The CPU 10A corresponds to one example of a hardware processor. The ROM 10B stores a program and the like for the CPU 10A to perform various pieces of processing. The RAM 10C stores data necessary for the CPU 10A to perform various pieces of processing. The I/F 10D is an interface connected to the imager 12, the detector 14, the display 16, and the ECU 3 and used to transmit and receive data.

A program for executing image processing executed by the image processing apparatus 10 of the embodiment is provided by being preliminarily incorporated in the ROM 10B or the like. Note that the program executed by the image processing apparatus 10 of the embodiment may be provided by being recorded in a recording medium as a file in a format in which the program can be installed or executed in the image processing apparatus 10. The recording medium can be read by a computer. The recording medium includes a compact disc ROM (CD-ROM), a flexible disk (FD), a CD-Recordable (CD-R), a digital versatile disk (DVD), a universal serial bus (USB) memory, and a secure digital (SD) card.

Next, a functional configuration of the image processing apparatus 10 according to the embodiment will be described. The image processing apparatus 10 simultaneously estimates position information on a detection point and self-position information on the moving object 2 from a captured image captured by the imager 12 by Visual SLAM processing. The image processing apparatus 10 combines a plurality of spatially adjacent captured images to generate and display a composite image overlooking the periphery of the moving object 2. Note that, in the embodiment, the imager 12 is used as the detector 14.

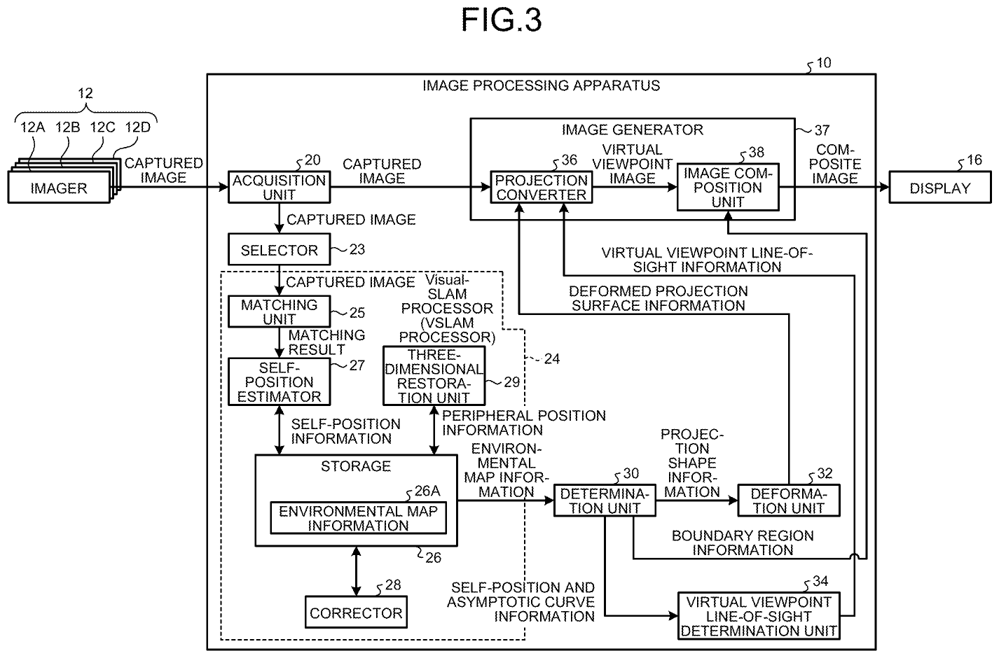

FIG. 3 illustrates one example of the functional configuration of the image processing apparatus 10. Note that, in order to clarify data input/output relation, FIG. 3 illustrates the imager 12 and the display 16 together with the image processing apparatus 10.

The image processing apparatus 10 includes an acquisition unit 20, a selector 23, a Visual-SLAM processor 24 (hereinafter, referred to as “VSLAM processor 24”), a determination unit 30, a deformation unit 32, a virtual viewpoint line-of-sight determination unit 34, a projection converter 36, and an image composition unit 38.

Some or all of the plurality of above-described units may be implemented by causing a processing device such as the CPU 10A to execute a program, that is, by software, for example. Furthermore, some or all of the plurality of above-described units may be implemented by hardware such as an integrated circuit (IC), or may be implemented by using software and hardware together.

The acquisition unit 20 acquires a captured image from the imager 12. The acquisition unit 20 acquires a captured image from each of the imagers 12 (imagers 12A to 12D).

Each time a captured image is acquired, the acquisition unit 20 outputs the acquired captured image to the projection converter 36 and the selector 23.

The selector 23 selects a detection region of a detection point. In the embodiment, the selector 23 selects the detection region by selecting at least one of the plurality of imagers 12 (imagers 12A to 12D).

In the embodiment, the selector 23 selects at least one of the imagers 12 by using vehicle state information and detection direction information included in the CAN data received from the ECU 3 or instruction information input by an operation instruction from a user.

The vehicle state information indicates, for example, a traveling direction of the moving object 2, a state of a direction instruction of the moving object 2, and a state of a gear of the moving object 2. The vehicle state information can be derived from the CAN data. The detection direction information indicates a direction in which information to be noted has been detected, and can be derived by a point of interest (POI) technique. The instruction information indicates a direction to be noted, and is input by an operation instruction from the user.

For example, the selector 23 selects the direction of the detection region by using the vehicle state information. Specifically, the selector 23 specifies parking information such as rear parking information and parallel parking information by using the vehicle state information. The rear parking information indicates rear parking of the moving object 2. The parallel parking information indicates parallel parking. The selector 23 preliminarily stores the parking information and identification information on one of the imagers 12 in association with each other. For example, the selector 23 preliminarily stores identification information on the imager 12D (see FIG. 1) that images the rear of the moving object 2 in association with the rear parking information. Furthermore, the selector 23 preliminarily stores identification information on each of the imager 12B and the imager 12C (see FIG. 1), which image the left and right directions of the moving object 2, in association with the parallel parking information.

Then, the selector 23 selects the direction of the detection region by selecting the imager 12 corresponding to the parking information derived from the received vehicle state information.

Furthermore, the selector 23 may select the imager 12 having the direction indicated by the detection direction information as the imaging region E. Furthermore, the selector 23 may select the imager 12 having the direction indicated by the detection direction information derived by a POI technique as the imaging region E.

The selector 23 outputs a captured image captured by the selected imager 12 among the captured images acquired by the acquisition unit 20 to the VSLAM processor 24.

The VSLAM processor 24 executes Visual SLAM processing by using the captured image received from the selector 23 to generate environmental map information, and outputs the generated environmental map information to the determination unit 30.

Specifically, the VSLAM processor 24 includes a matching unit 25, a storage 26, a self-position estimator 27, a corrector 28, and a three-dimensional restoration unit 29.

The matching unit 25 performs processing of extracting feature amounts from a plurality of captured images at different imaging timings (plurality of captured images with different frames) and matching processing between the images. Specifically, the matching unit 25 performs processing of extracting feature amounts from the plurality of captured images. The matching unit 25 performs matching processing of specifying corresponding points between the plurality of captured images at different imaging timings by using feature amounts between the plurality of captured images. The matching unit 25 outputs a result of the matching processing to the self-position estimator 27.

The self-position estimator 27 estimates a relative self-position with respect to the captured images by projective transformation or the like by using a plurality of matching points acquired from the matching unit 25. Here, the self-position includes information on the position (three-dimensional coordinates) and inclination (rotation) of the imager 12. The self-position estimator 27 stores the information in environmental map information 26A as the self-position information.

The three-dimensional restoration unit 29 performs the perspective projection conversion processing by using an amount of movement (amount of translation and amount of rotation) of the self-position estimated by the self-position estimator 27, and determines the three-dimensional coordinates of the matching points (relative coordinates with respect to self-position). The three-dimensional restoration unit 29 stores the determined three-dimensional coordinates in the environmental map information 26A as peripheral position information.

As a result, new peripheral position information and self-position information are sequentially added to the environmental map information 26A with movement of the moving object 2 mounted with the imager 12.

The storage 26 stores various pieces of data. Examples of the storage 26 include a semiconductor memory element, such as a RAM and a flash memory, a hard disk, and an optical disk. Note that the storage 26 may be a storage device provided outside the image processing apparatus 10. Furthermore, the storage 26 may be a storage medium. Specifically, programs and various pieces of information may be stored or temporarily stored in the storage medium by being downloaded via a local area network (LAN) and the Internet.

The environmental map information 26A is obtained by registering the peripheral position information calculated by the three-dimensional restoration unit 29 and the self-position information calculated by the self-position estimator 27 in three-dimensional coordinate space with a predetermined position in real space as the origin. The predetermined position in real space may be determined under a preset condition, for example.

For example, the predetermined position is a position of the moving object 2 at the time when the image processing apparatus 10 executes the image processing of the embodiment. For example, a case where image processing is executed at predetermined timing, such as a scene of parking the moving object 2, is assumed. In this case, the image processing apparatus 10 may determine the position of the moving object 2 at the time of determining that the predetermined timing has come as the predetermined position. For example, when determining that the moving object 2 exhibits behavior indicating a parking scene, the image processing apparatus 10 is required to determine that the predetermined timing has come. Examples of the behavior indicating a parking scene include a case where the speed of the moving object 2 is equal to or less than a predetermined speed, a case where the moving object 2 shifts into back gear, and a case where a signal indicating parking start is received by an operation instruction from the user and the like. Note that the predetermined timing is not limited to the parking scene.

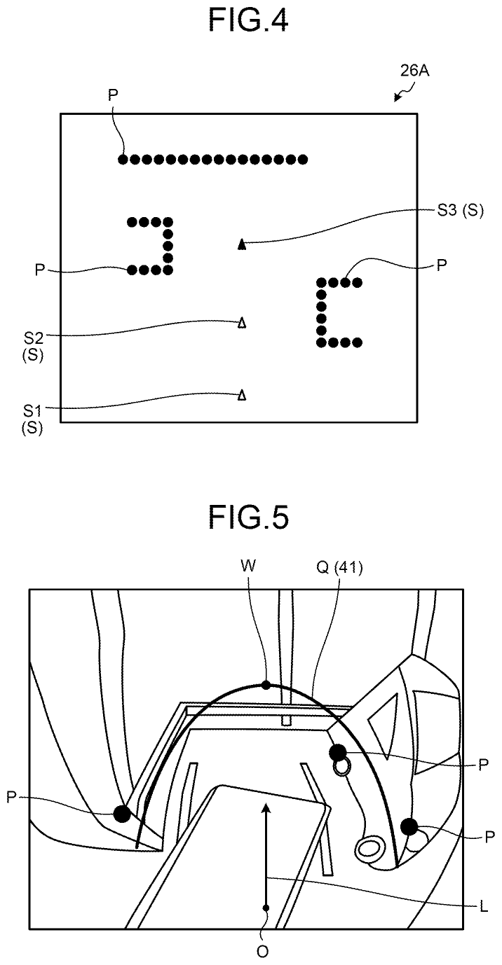

FIG. 4 is a schematic diagram illustrating one example of the environmental map information 26A. As illustrated in FIG. 4, in the environmental map information 26A, position information (peripheral position information) on each of detection points P and self-position information on self-positions S of the moving object 2 are registered in corresponding coordinate positions in the three-dimensional coordinate space. In one example, the self-positions S of self-positions S1 to S3 are illustrated. A larger numerical value following S means a self-position S closer to the current timing.

The corrector 28 corrects the peripheral position information and the self-position information registered in the environmental map information 26A by using, for example, a least-squares method such that the total of differences of distances in the three-dimensional space between three-dimensional coordinates calculated in the past of one of points matched a plurality of times between a plurality of frames and newly calculated three-dimensional coordinates of one of the points is minimized. Note that the corrector 28 may correct the amount of movement (amount of translation and amount of rotation) of the self-position used in the process of calculating the self-position information and the peripheral position information.

The timing of the correction processing performed by the corrector 28 is not limited. For example, the corrector 28 is required to execute the above-described correction processing at each predetermined timing. The predetermined timing may be determined under a preset condition, for example. Note that, in the embodiment, a case where the image processing apparatus 10 includes the corrector 28 will be described as one example. The image processing apparatus 10 is, however, not required to include the corrector 28.

The determination unit 30 receives the environmental map information from the VSLAM processor 24, and calculates a measurement distance between the moving object 2 and a peripheral three-dimensional object by using the peripheral position information and the self-position information accumulated in the environmental map information 26A. Here, the measurement distance means a distance between objects measured by processing using a distance sensor and an image (VSLAM processing in embodiment). The measurement distance is obtained by processing using a distance sensor and an image, so that the measurement distance can have any value depending on the situation. In that sense, the measurement distance is a continuous value.

The determination unit 30 executes distance stabilization processing of converting a measurement distance into a stabilization distance. Here, the stabilization distance means a discrete distance (discontinuous value) acquired based on the measurement distance. The distance stabilization processing will be described in detail later. Note that the determination unit 30 is one example of a converter.

Furthermore, the determination unit 30 determines the projection shape of a projection surface by using the stabilization distance obtained by the distance stabilization processing, and generates projection shape information. The determination unit 30 outputs the generated projection shape information to the deformation unit 32.

Here, the projection surface is a three-dimensional surface for projecting a peripheral image of the moving object 2. Furthermore, the peripheral image of the moving object 2 is a captured image of the periphery of the moving object 2, and is a captured image captured by each of the imagers 12A to 12D. The projection shape of the projection surface is a three-dimensional (3D) shape virtually formed in virtual space corresponding to the real space. Furthermore, in the embodiment, the determination of the projection shape of the projection surface executed by the determination unit 30 is referred to as projection shape determination processing.

Furthermore, the determination unit 30 calculates an asymptotic curve of the peripheral position information with respect to the self-position by using the peripheral position information and the self-position information of the moving object 2 accumulated in the environmental map information 26A.

FIG. 5 is an explanatory diagram of an asymptotic curve Q generated by the determination unit 30. Here, the asymptotic curve is an asymptotic curve of a plurality of detection points P in the environmental map information 26A. FIG. 5 illustrates an example in which the asymptotic curve Q is indicated in a projection image obtained by projecting a captured image on a projection surface in a case where the moving object 2 is overlooked from above. For example, it is assumed that the determination unit 30 specifies three detection points P in order of proximity to the self-position S of the moving object 2. In this case, the determination unit 30 generates the asymptotic curve Q of these three detection points P.

The determination unit 30 outputs the self-position and asymptotic curve information to the virtual viewpoint line-of-sight determination unit 34.

Note that a configuration of the determination unit 30 will be described in detail later.

The deformation unit 32 deforms the projection surface based on the projection shape information received from the determination unit 30.

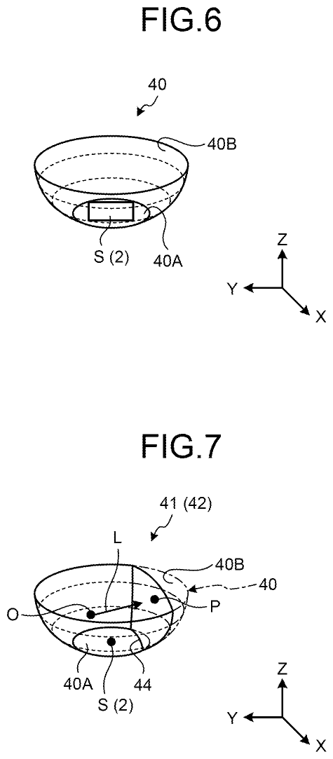

FIG. 6 is a schematic diagram illustrating one example of a reference projection surface 40. FIG. 7 is a schematic diagram illustrating one example of a projection shape 41 determined by the determination unit 30. That is, the deformation unit 32 deforms the preliminarily stored reference projection surface in FIG. 6 based on the projection shape information, and determines a deformed projection surface 42 serving as the projection shape 41 in FIG. 7. The determination unit 30 generates deformed projection surface information based on the projection shape 41. The reference projection surface is deformed based on a detection point P closest to the moving object 2, for example. The deformation unit 32 outputs the deformed projection surface information to the projection converter 36.

Furthermore, for example, the deformation unit 32 deforms the reference projection surface into a shape along the asymptotic curve of a plurality of detection points P predetermined in order of proximity to the moving object 2 based on the projection shape information.

The virtual viewpoint line-of-sight determination unit 34 determines virtual viewpoint line-of-sight information based on the self-position and the asymptotic curve information.

The determination of the virtual viewpoint line-of-sight information will be described with reference to FIGS. 5 and 7. For example, the virtual viewpoint line-of-sight determination unit 34 determines, as a line-of-sight direction, a direction that passes through a detection point P closest to the self-position S of the moving object 2 and that is perpendicular to the deformed projection surface. Furthermore, for example, the virtual viewpoint line-of-sight determination unit 34 fixes the direction of a line-of-sight direction L, and determines the coordinates of a virtual viewpoint O as any Z coordinate and optional XY coordinates in a direction away from the asymptotic curve Q to the self-position S. In that case, the XY coordinates may be coordinates of a position farther away from the asymptotic curve Q than the self-position S. Then, the virtual viewpoint line-of-sight determination unit 34 outputs the virtual viewpoint line-of-sight information indicating the virtual viewpoint O and the line-of-sight direction L to the projection converter 36. Note that, as illustrated in FIG. 7, the line-of-sight direction L may be a direction from the virtual viewpoint O toward the position of a vertex W of the asymptotic curve Q.

The projection converter 36 generates a projection image obtained by projecting a captured image acquired from the imager 12 on the deformed projection surface based on the deformed projection surface information and the virtual viewpoint line-of-sight information. The projection converter 36 converts the generated projection image into a virtual viewpoint image, and outputs the virtual viewpoint image to the image composition unit 38. Here, the virtual viewpoint image is obtained by visually recognizing a projection image in any direction from the virtual viewpoint.

Projection image generation processing performed by the projection converter 36 will be described in detail with reference to FIG. 7. The projection converter 36 projects a captured image onto the deformed projection surface 42. Then, the projection converter 36 generates a virtual viewpoint image (not illustrated), which is obtained by visually recognizing a captured image projected onto the deformed projection surface 42 in the line-of-sight direction L from any virtual viewpoint O. The position of the virtual viewpoint O may be, for example, the latest self-position S of the moving object 2. In this case, the XY coordinates of the virtual viewpoint O are required to have a value of the XY coordinates of the latest self-position S of the moving object 2. Furthermore, the Z coordinate (position in vertical direction) of the virtual viewpoint O is required to have a value of the Z coordinate of the detection point P closest to the self-position S of the moving object 2. The line-of-sight direction L may be determined based on a predetermined reference, for example.

The line-of-sight direction L may be a direction from the virtual viewpoint O toward the detection point P closest to the self-position S of the moving object 2, for example. Furthermore, the line-of-sight direction L may be a direction that passes through the detection point P and that is perpendicular to the deformed projection surface 42. The virtual viewpoint line-of-sight determination unit 34 creates the virtual viewpoint line-of-sight information indicating the virtual viewpoint O and the line-of-sight direction L.

For example, the virtual viewpoint line-of-sight determination unit 34 determines, as the line-of-sight direction L, a direction that passes through the detection point P closest to the self-position S of the moving object 2 and that is perpendicular to the deformed projection surface 42. Furthermore, the virtual viewpoint line-of-sight determination unit 34 may fixe the direction of the line-of-sight direction L, and determine the coordinates of a virtual viewpoint O as any Z coordinate and optional XY coordinates in a direction away from the asymptotic curve Q to the self-position S. In that case, the XY coordinates may be coordinates of a position farther away from the asymptotic curve Q than the self-position S. Then, the virtual viewpoint line-of-sight determination unit 34 outputs the virtual viewpoint line-of-sight information indicating the virtual viewpoint O and the line-of-sight direction L to the projection converter 36. Note that, as illustrated in FIG. 7, the line-of-sight direction L may be a direction from the virtual viewpoint O toward the position of a vertex W of the asymptotic curve Q.

The projection converter 36 receives the virtual viewpoint line-of-sight information from the virtual viewpoint line-of-sight determination unit 34. The projection converter 36 receives the virtual viewpoint line-of-sight information, and specifies the virtual viewpoint O and the line-of-sight direction L. Then, the projection converter 36 generates a virtual viewpoint image, which is obtained by visually recognizing a captured image projected onto the deformed projection surface 42 in the line-of-sight direction L from any virtual viewpoint O. The projection converter 36 outputs the virtual viewpoint image to the image composition unit 38.

The image composition unit 38 generates a composite image obtained by extracting a part or all of the virtual viewpoint image. For example, the image composition unit 38 performs processing of combining a plurality of virtual viewpoint images in boundary regions between imagers (here, four virtual viewpoint images captured by imagers 12A to 12D).

The image composition unit 38 outputs the generated composite image to the display 16. Note that the composite image may be a birds-eye image with the virtual viewpoint O set on an upper side of the moving object 2. The composite image may translucently display the moving object 2 with the virtual viewpoint O set in the moving object 2.

Note that the projection converter 36 and the image composition unit 38 constitute an image generator 37.

Configuration Example of Determination Unit 30

Next, one example of a detailed configuration of the determination unit 30 will be described.

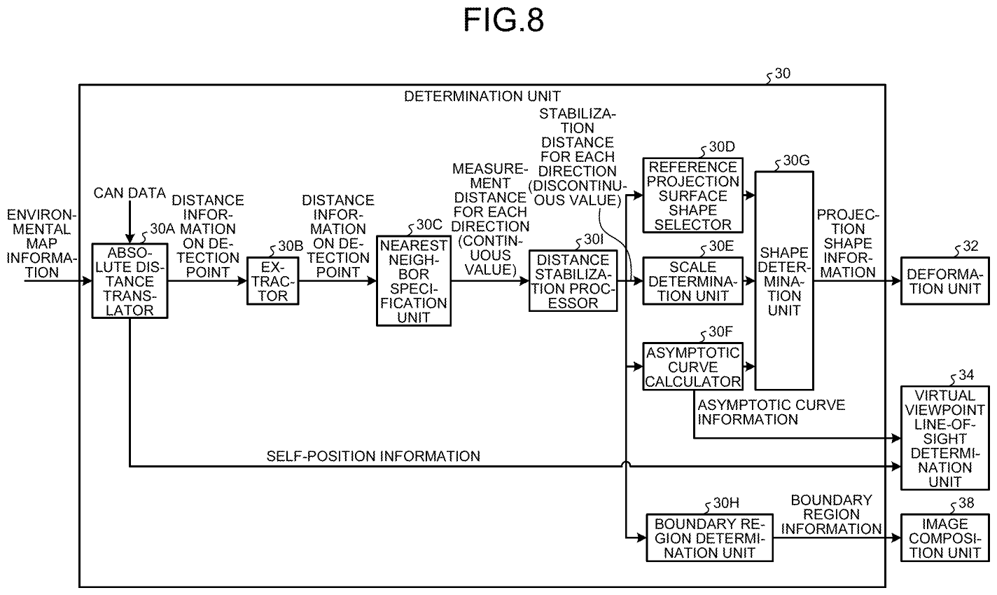

FIG. 8 is a schematic diagram illustrating one example of the configuration of the determination unit 30. As illustrated in FIG. 8, the determination unit 30 includes an absolute distance translator 30A, an extractor 30B, a nearest neighbor specification unit 30C, a distance stabilization processor 30I, a reference projection surface shape selector 30D, a scale determination unit 30E, an asymptotic curve calculator 30F, a shape determination unit 30G, and a boundary region determination unit 30H.

The absolute distance translator 30A translates the relative positional relation between the self-position and a peripheral three-dimensional object, which can be known from the environmental map information 26A, into an absolute value of the distance from the self-position to the peripheral three-dimensional object.

Specifically, for example, speed data on the moving object 2 included in the CAN data received from the ECU 3 of the moving object 2 is used. For example, although, in a case of the environmental map information 26A in FIG. 4, the relative positional relation between the self-position S and a plurality of detection points P can be known, the absolute values of the distances therebetween are not calculated. Here, the distance between the self-position S3 and the self-position S2 can be determined from a cycle between frame in which a self-position is calculated and speed data therebetween in the CAN data. Since the relative positional relation of the environmental map information 26A is analogous to that in the real space, absolute values of distances (measurement distance) from the self-position S to all detection points P other than the self-position S can be determined by knowing the distance between the self-position S3 and the self-position S2. Note that, when the detector 14 acquires the distance information on the detection point P, the absolute distance translator 30A may be omitted.

Then, the absolute distance translator 30A outputs the calculated measurement distance of each of the plurality of detection points P to the extractor 30B. Furthermore, the absolute distance translator 30A outputs the calculated current position of the moving object 2 to the virtual viewpoint line-of-sight determination unit 34 as the self-position information on the moving object 2.

The extractor 30B extracts a detection point P present within a specific range among the plurality of detection points P whose measurement distances have been received from the absolute distance translator 30A. The specific range is, for example, a range from a road surface on which the moving object 2 is disposed to a height corresponding to the height of the moving object 2. Note that the range is not limited to this range.

The extractor 30B extracts a detection point P within the range, which enables extraction of the detection point P such as an object that obstructs traveling of the moving object 2 and an object located adjacent to the moving object 2.

Then, the extractor 30B outputs a measurement distance of each of the extracted detection points P to the nearest neighbor specification unit 30C.

The nearest neighbor specification unit 30C divides the periphery of the self-position S of the moving object 2 into respective specific ranges (e.g., angular ranges), and specifies a detection point P closest to the moving object 2 or a plurality of detection points P in order of proximity to the moving object 2. The nearest neighbor specification unit 30C specifies a detection point P by using a measurement distance received from the extractor 30B. In the embodiment, a mode in which the nearest neighbor specification unit 30C specifies a plurality of detection points P in order of proximity to the moving object 2 for each range will be described as one example.

The nearest neighbor specification unit 30C outputs the measurement distance of the detection point P specified for each range to the distance stabilization processor 30I.

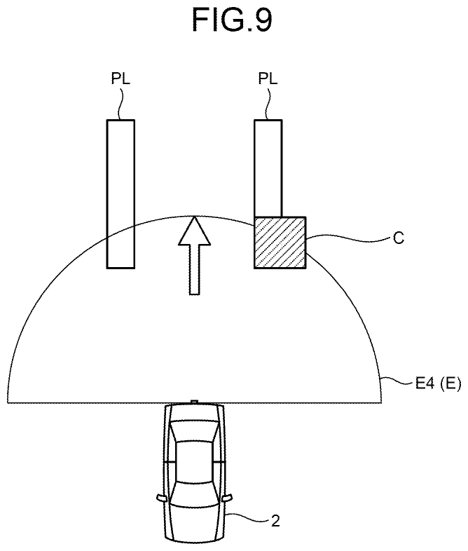

The distance stabilization processor 30I executes distance stabilization processing of converting a measurement distance into a stabilization distance. Here, the distance stabilization processing executed by the distance stabilization processor 30I includes first distance stabilization processing and second distance stabilization processing. Each of the first distance stabilization processing and the second distance stabilization processing will be described in detail below with reference to FIGS. 9 to 14.

First Distance Stabilization Processing

In the first distance stabilization processing, a measurement distance of a detection point P specified for each range is converted into a first distance or a second distance smaller than the first distance, which serves as a stabilization distance, based on the magnitude relation between the measurement distance and a threshold.

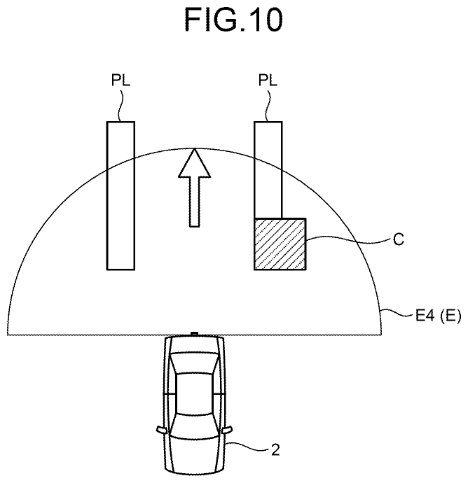

FIG. 9 is a plan view illustrating one example of a situation in which the moving object 2 is parked rearward between parking lot lines PL on one of which a column C is located. FIG. 10 is a plan view illustrating one example of a situation in which the moving object 2 has traveled rearward and the moving object 2 has further approached the column C as compared with the situation in FIG. 9. In order to make the description specific, distance stabilization processing in a case where the moving object 2 performs rear parking will be described below.

In the situations in FIGS. 9 and 10, the column C is located in an imaging region E4 of the imager 12D. Therefore, the measurement distances of a plurality of detection points P related to the column C specified for each range are sequentially output from the nearest neighbor specification unit 30C to the distance stabilization processor 30I.

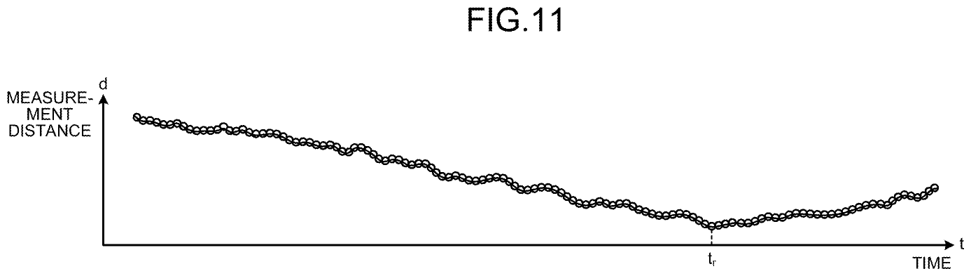

FIG. 11 illustrates one example of a temporal change in the measurement distance of the detection point P of the column C closest to the moving object 2. Note that a circle in FIG. 11 indicates one acquisition of a measurement distance. As illustrated in FIG. 11, a measurement distance d of the detection point P decreases as the moving object 2 travels rearward and approaches the column C. Note that an increase of the measurement distance d from a time tᵣ indicates that the moving object 2 has once traveled forward to turn the direction of the moving object 2 at the time of rear parking.

Here, as illustrated in FIG. 11, the measurement distance d fluctuates including a slight increase amount or decrease amount in addition to a change amount with rearward traveling of the moving object 2 in a period up to the time tᵣ, for example. The fluctuation is caused by a measurement error (measurement value fluctuation due to noise and other factors) of a measurement distance obtained by using a sensor (measurement distance obtained by Visual SLAM processing using captured image in case of embodiment).

Therefore, when a projection surface is deformed in accordance with the fluctuating measurement distance d as illustrated in FIG. 11, the projection surface is frequently deformed in a direction approaching the moving object 2 or a direction away from the moving object 2 in conjunction with the fluctuation of the measurement distance d (Hereinafter, this phenomenon is also referred to as “first fluctuation of a projection surface”). As a result, when an image projected on a projection surface (projection image) on which temporal fluctuation has occurred is displayed, the projection image fluctuates, and a video appears to be disturbed. The first distance stabilization processing solves such a problem that a projection image becomes unnatural due to the first fluctuation of the projection surface.

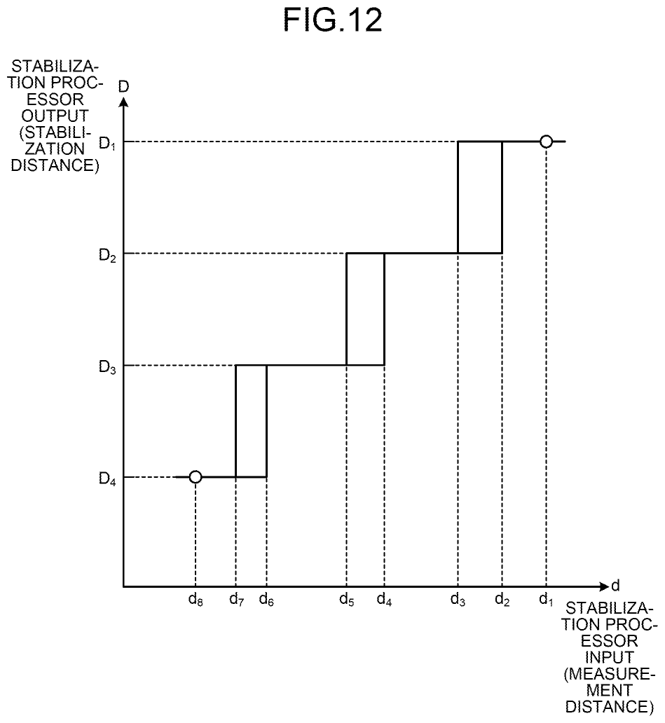

FIG. 12 is a graph illustrating one example of the relation between input and output of the distance stabilization processor 30I. In the graph of FIG. 12, a horizontal axis represents the measurement distance d, and a vertical axis represents the stabilization distance D. The measurement distance d is input of the distance stabilization processor 30I. The stabilization distance D is output of the distance stabilization processor 30I.

As the moving object 2 travels rearward, the moving object 2 approaches the column C. For example, as illustrated in FIG. 11, the measurement distance d between the moving object 2 and the column C fluctuates including a slight increase amount or decrease amount in addition to a change amount with the rearward traveling of the moving object 2. As illustrated in FIG. 12, however, the distance stabilization processor 30I converts the measurement distance d into a stabilization distance D₁ and outputs the stabilization distance D₁ until the measurement distance d gradually decreasing from d₁ with the rearward traveling of the moving object 2 becomes smaller than a threshold d₃. In contrast, when the measurement distance d becomes smaller than the threshold d₃, the distance stabilization processor 30I converts the measurement distance d into the stabilization distance D₂ and outputs the stabilization distance D₂. Note that, in this case, the threshold d₃ is one example of a first threshold serving as a down determination threshold (threshold for determining down of stabilization distance). Furthermore, the stabilization distance D₁ and the stabilization distance D₂ are examples of a first distance serving as a stabilization distance before down and a second distance serving as a stabilization distance after down, respectively.

Furthermore, the measurement distance d between the moving object 2 and the column C further decreases as the moving object 2 travels rearward. As illustrated in FIG. 12, the distance stabilization processor 30I converts the measurement distance d into the stabilization distance D₂ and outputs the stabilization distance D₂ until the measurement distance d becomes smaller than the threshold d₃ and then further becomes smaller than a threshold d₅ which is smaller than the threshold d₃. In contrast, when the measurement distance d to be input becomes smaller than the threshold d₅, the distance stabilization processor 30I converts the measurement distance d into the stabilization distance D₃ and outputs the stabilization distance D₃. Note that, in this case, the threshold d₅ is one example of a third threshold serving as a down determination threshold. Furthermore, the stabilization distance D₂ and the stabilization distance D₃ are examples of a second distance serving as a stabilization distance before down and a third distance serving as a stabilization distance after down, respectively.

Similarly, the distance stabilization processor 30I converts the measurement distance d into the stabilization distance D₃ and outputs the stabilization distance D₃ until the sequentially input measurement distance d becomes smaller than a threshold d₅. In contrast, when the sequentially input measurement distance d becomes smaller than the threshold d₅ serving as a down determination threshold, the distance stabilization processor 30I converts the measurement distance d into a stabilization distance D₄ serving as a stabilization distance after down and outputs the stabilization distance D₄. This can inhibit occurrence of fluctuation of a projection surface since the deformation unit 32 deforms the projection surface by using information on the stabilization distance D even if the measurement distance d fluctuates.

Second Distance Stabilization Processing

Next, the second distance stabilization processing will be described. The second distance stabilization processing further solves the problem that a projection image becomes unnatural due to the temporal fluctuation of the projection surface at the time when the first distance stabilization processing is executed. That is, in the second distance stabilization processing, after the measurement distance becomes smaller than the first threshold, the measurement distance is converted into the first distance or the second distance based on the magnitude relation between the acquired measurement distance and a second threshold larger than the first threshold.

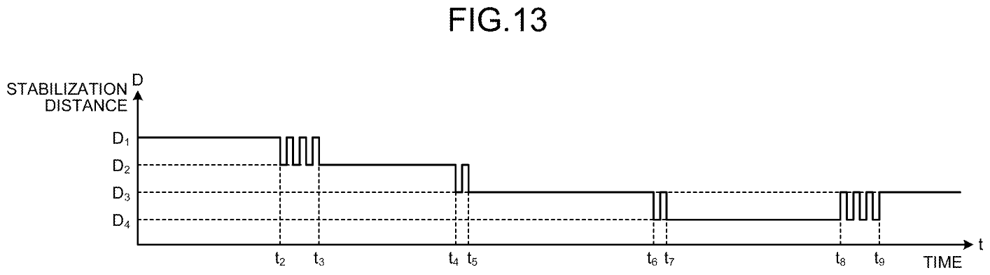

FIG. 13 illustrates one example of a temporal change in the stabilization distance D obtained by the first distance stabilization processing using the measurement distance d of the detection point P of the column C in FIG. 11 as input. According to the first distance stabilization processing, as illustrated in FIG. 13, the measurement distance d in FIG. 11 including many fluctuations can be converted into the stabilization distance D with less fluctuations. Therefore, a stable projection image can be displayed by using a projection surface with inhibited fluctuation.

In contrast, in FIG. 13, the stabilization distance D fluctuates between D₁ and D₂ in a period from a time t₂ to a time t₃. Furthermore, the stabilization distance D fluctuates between D₂ and D₃ in a period from a time t₄ to a time t₅, between D₃ and D₄ in a period from a time t₆ to a time t₇, and between D₄ and D₅ in a period from a time t₈ to a time t₉.

The fluctuation of the stabilization distance D in each of the above-described periods is caused by the measurement distance d repeatedly fluctuating to become larger or smaller than the threshold d₃ in FIG. 12 due to factors such as noise and the stabilization distance D also fluctuating between D₁ and D₂ in conjunction with the fluctuations in, for example, the period from the time t₂ to the time t₃ in FIG. 13. The shape of the projection surface is determined in accordance with a value of the stabilization distance D. Thus, in the period from the time t₂ to the time t₃ corresponding to before and after switching of the stabilization distance, the projection surface is frequently deformed in conjunction with the fluctuations of the stabilization distance D (Hereinafter, this phenomenon is also referred to as “second fluctuation of a projection surface”). As a result, disturbance of a video occurs in a period before and after switching of the stabilization distance (i.e., period before or after measurement distance d steps over down determination threshold). In the disturbance of a video, the projection image stably displayed by the first distance stabilization processing fluctuates. The second distance stabilization processing solves such a problem that a projection image becomes unnatural due to the second fluctuation of the projection surface.

For example, as illustrated in FIG. 12, when the measurement distance d is smaller than the threshold d₃ and the stabilization distance D has been converted into D₂, the distance stabilization processor 30I does not convert the stabilization distance D into D₁ even when the measurement distance d becomes larger than the threshold d₃. That is, when the measurement distance d is smaller than the threshold d₃, the distance stabilization processor 30I does not convert the stabilization distance D into D₁ unless the measurement distance d becomes larger than a threshold d₂ which is larger than the threshold d₃. Therefore, a dead zone is formed between the threshold d₃ and the threshold d₂. Note that, in this case, the threshold d₃ is one example of the first threshold serving as a down determination threshold. Furthermore, the threshold d₂ is one example of the second threshold serving as an up determination threshold (threshold for determining up of stabilization distance).

Furthermore, for example, as illustrated in FIG. 12, when the measurement distance d is smaller than the threshold d₅ and the stabilization distance D has been converted into D₃, the distance stabilization processor 30I does not convert the stabilization distance D into D₂ even when the measurement distance d becomes larger than the threshold d₅. That is, when the measurement distance d is smaller than the threshold d₅, the distance stabilization processor 30I does not convert the stabilization distance D into D₂ unless the measurement distance d becomes larger than a threshold d₄ which is larger than the threshold d₅. Therefore, a dead zone is formed between the threshold d₅ and the threshold d₄. Note that, in this case, the threshold d₅ is one example of the first threshold serving as a down determination threshold. The threshold d₄ is one example of the second threshold serving as an up determination threshold.

Similarly, as illustrated in FIG. 12, when the measurement distance d is smaller than the threshold d₇ and the stabilization distance D has been converted into D₄, the distance stabilization processor 30I does not convert the stabilization distance D into D₃ even when the measurement distance d becomes larger than the threshold d₇. That is, when the measurement distance d is smaller than the threshold d₇, the distance stabilization processor 30I does not convert the stabilization distance D into D₃ unless the measurement distance d becomes larger than a threshold d₆ which is larger than the threshold d₇. Therefore, a dead zone is formed between the threshold d₇ and the threshold d₆. Note that, in this case, the threshold d₇ is one example of the first threshold serving as a down determination threshold. The threshold d₆ is one example of the second threshold serving as an up determination threshold.

Note that, in the second distance stabilization processing in accordance with the relation between input and output in FIG. 12, after the measurement distance d once becomes smaller than the first threshold, the value of the stabilization distance D is determined not by the magnitude relation between the measurement distance d input thereafter and the first threshold but by the magnitude relation with the second threshold larger than the first threshold. That is, the value of the stabilization distance D is controlled by a history of the measurement distance d. In that sense, the second distance stabilization processing can be referred to as hysteresis processing of the stabilization distance D.

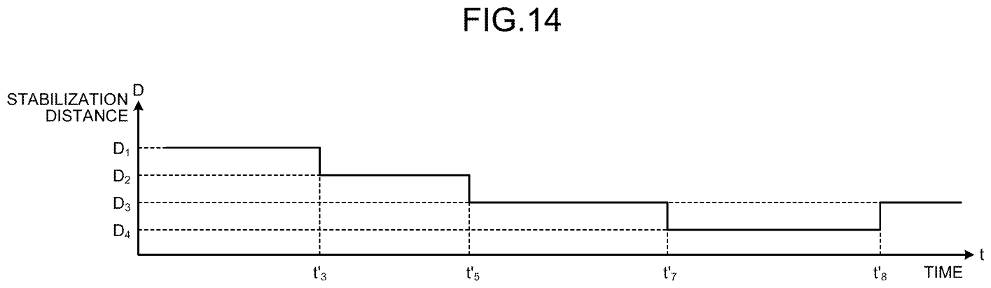

FIG. 14 illustrates one example of a temporal change in the stabilization distance D obtained by the first and second pieces of distance stabilization processing using the measurement distance of the detection point P of the column C in FIG. 11 as input. Note that, in FIG. 14, the time when the stabilization distance D is converted from D₁ to D₂ is defined as t′₃. The time when the stabilization distance D is converted from D₂ to D₃ is defined as t′₅. The time when the stabilization distance D is converted from D₃ to D₄ is defined as t′₇. The time when the stabilization distance D is converted from D₄ to D₃ is defined as t′ 8. As can be seen by comparison between FIG. 14 and FIG. 13, the fluctuations of the stabilization distance D in periods before and after the down determination thresholds or the up determination thresholds are eliminated.

Furthermore, in FIG. 12, the dead zone defined by the threshold d₃ and the threshold d₂, the dead zone defined by the threshold d₅ and the threshold d₄, and the dead zone defined by the threshold d₇ and the threshold d₆ have different lengths. This is because the accuracy of a distance sensor (in this case, VSLAM processor 24) changes depending on the measurement distance from the moving object 2 to the three-dimensional object. The width of each dead zone can be optionally set by adjusting each threshold in accordance with the measurement accuracy of the distance sensor. For example, when the measurement accuracy of the distance sensor is ±5% of an absolute distance, the width of the dead zone may be set to increase as the measurement distance d increases as in the example in FIG. 12.

Furthermore, for example, after the measurement distance d becomes smaller than the threshold d₃ and the stabilization distance D has been converted into De r when the measurement distance d becomes smaller than the threshold d₅ as the moving object 2 travels rearward, the distance stabilization processor 30I converts the stabilization distance D into D₃ in accordance with the first distance stabilization processing. In this case, the threshold d₃ and the threshold d₅ are examples of the first threshold and the third threshold, respectively. The stabilization distances D₂ and D₃ are examples of the second distance and the third distance, respectively.

The distance stabilization processor 30I outputs the stabilization distance of the detection point P specified for each range obtained by the distance stabilization processing to the reference projection surface shape selector 30D, the scale determination unit 30E, the asymptotic curve calculator 30F, and the boundary region determination unit 30H.

The reference projection surface shape selector 30D selects the shape of a reference projection surface.

Here, the reference projection surface will be described in detail with reference to FIG. 6. The reference projection surface 40 has a shape which serves as a reference at the time when the shape of the projection surface is changed, for example. The reference projection surface 40 has, for example, a bowl shape and a cylindrical shape. Note that FIG. 6 illustrates a bowl-shaped reference projection surface 40.

In the bowl shape, a bottom surface 40A and a side wall surface 40B are provided. One end of the side wall surface 40B is continuous with the bottom surface 40A. The other end thereof is opened. The side wall surface 40B has a width in a horizontal cross section increasing from the side of the bottom surface 40A toward the opening side of the other end. The bottom surface 40A has, for example, a circular shape. Here, the circular shape includes a shape of a perfect circle and a shape of a circle other than the perfect circle, such as an elliptical shape. The horizontal cross section is an orthogonal plane orthogonal to the vertical direction (arrow Z direction). The orthogonal plane is a two-dimensional plane along an arrow X direction and an arrow Y direction. The arrow X direction is orthogonal to the arrow Z direction. The arrow Y direction is orthogonal to the arrow Z direction and the arrow X direction. In the following description, the horizontal cross section and the orthogonal plane may be referred to as XY planes. Note that the bottom surface 40A may have a shape other than a circular shape, such as an egg shape.

The cylindrical shape includes a circular bottom surface 40A and a side wall surface 40B continuous with the bottom surface 40A. Furthermore, the side wall surface 40B constituting a cylindrical reference projection surface 40 has a cylindrical shape in which an opening at one end is continuous with the bottom surface 40A and the other end is opened. Note, however, that the side wall surface 40B constituting the cylindrical reference projection surface 40 has a shape in which the diameter in the XY plane is substantially constant from the side of the bottom surface 40A toward the opening side of the other end. Note that the bottom surface 40A may have a shape other than a circular shape, such as an egg shape.

In the embodiment, a case where the reference projection surface 40 has a bowl shape in FIG. 6 will be described as one example. The reference projection surface 40 is a three-dimensional model virtually formed in virtual space in which the bottom surface 40A is defined as a surface substantially coinciding with a road surface below the moving object 2 and the center of the bottom surface 40A is defined as the self-position S of the moving object 2.

The reference projection surface shape selector 30D selects the shape of the reference projection surface 40 by reading the shape of a specific one of a plurality of types of reference projection surfaces 40. For example, the reference projection surface shape selector 30D selects the shape of the reference projection surface 40 in accordance with the positional relation between the self-position and a peripheral three-dimensional object, the stabilization distance, and the like. Note that the shape of the reference projection surface 40 may be selected by an operation instruction from the user. The reference projection surface shape selector 30D outputs information on the determined shape of the reference projection surface 40 to the shape determination unit 30G. In the embodiment, a mode in which the reference projection surface shape selector 30D selects a bowl-shaped reference projection surface 40 as described above will be described as one example.

The scale determination unit 30E determines the scale of the reference projection surface 40 having the shape selected by the reference projection surface shape selector 30D. For example, when there is a plurality of detection points P in a range of a predetermined distance from the self-position S, the scale determination unit 30E determines to reduce the scale. The scale determination unit 30E outputs scale information on the determined scale to the shape determination unit 30G.

The asymptotic curve calculator 30F outputs, to the shape determination unit 30G and the virtual viewpoint line-of-sight determination unit 34, asymptotic curve information on the asymptotic curve Q calculated by using each of stabilization distances of detection points P closest to the self-position S for each range from the self-position S received from the nearest neighbor specification unit 30C. Note that the asymptotic curve calculator 30F may calculate the asymptotic curve Q of detection points P accumulated for each of a plurality of portions of the reference projection surface 40. Then, the asymptotic curve calculator 30F may output the asymptotic curve information on the calculated asymptotic curve Q to the shape determination unit 30G and the virtual viewpoint line-of-sight determination unit 34.

The shape determination unit 30G enlarges or reduces the reference projection surface 40 having the shape indicated by the shape information received from the reference projection surface shape selector 30D to the scale of the scale information received from the scale determination unit 30E. Then, the shape determination unit 30G determines, as the projection shape, a shape obtained by deforming the enlarged or reduced reference projection surface 40 such that the reference projection surface 40 follows the asymptotic curve information of the asymptotic curve Q received from the asymptotic curve calculator 30F.

Here, the determination of the projection shape will be described in detail with reference to FIG. 7. As illustrated in FIG. 7, the shape determination unit 30G determines, as the projection shape 41, a shape obtained by deforming the reference projection surface 40 such that the reference projection surface 40 passes through the detection point P closest to the self-position S of the moving object 2, which is the center of the bottom surface 40A of the reference projection surface 40. The shape passing through the detection point P means that the deformed side wall surface 40B passes through the detection point P. The self-position S corresponds to the latest self-position S calculated by the self-position estimator 27.

That is, the shape determination unit 30G specifies the detection point P closest to the self-position S among a plurality of detection points P registered in the environmental map information 26A. Specifically, the XY coordinates of the center position (self-position S) of the moving object 2 is set as (X, Y)=(0, 0). Then, the shape determination unit 30G specifies the detection point P at which the value of X 2+Y 2 indicates the minimum value as the detection point P closest to the self-position S. Then, the shape determination unit 30G determines, as the projection shape 41, a shape obtained by deforming the side wall surface 40B of the reference projection surface 40 such that the side wall surface 40B of the reference projection surface 40 passes through the detection point P.

More specifically, the shape determination unit 30G determines, as the projection shape 41, the bottom surface 40A and a deformed shape of a partial region of the side wall surface 40B such that the partial region of the side wall surface 40B becomes a wall surface passing through the detection point P closest to the moving object 2 at the time when the reference projection surface 40 is deformed. The deformed projection shape 41 is a shape of rising from a rising line 44 on the bottom surface 40A toward a direction approaching the center of the bottom surface 40A from a viewpoint of the XY plane (in plan view). The rising means, for example, parts of the side wall surface 40B and the bottom surface 40A being bent or folded toward the direction approaching the center of the bottom surface 40A such that an angle formed by the side wall surface 40B and the bottom surface 40A of the reference projection surface 40 is further reduced. Note that, in the rising shape, the rising line 44 may be located between the bottom surface 40A and the side wall surface 40B, and the bottom surface 40A may remain undeformed.

The shape determination unit 30G determines that a specific region in the reference projection surface 40 is to be deformed so as to protrude to a position passing through the detection point P from a viewpoint of XY plane (in plan view). The shape and range of the specific region may be determined based on a predetermined reference. Then, the shape determination unit 30G determines to adopt a shape in which the reference projection surface 40 is deformed such that the distance from the self-position S is continuously increased from the protruding specific region toward a region other than the specific region in the side wall surface 40B.

For example, as illustrated in FIG. 7, the projection shape 41 is preferably determined such that an outer periphery in a cross section along the XY plane has a curved shape. Note that, although the outer periphery in a cross section of the projection shape 41 has, for example, a circular shape, the outer periphery may have a shape other than the circular shape.

Note that the shape determination unit 30G may determine, as the projection shape 41, a shape obtained by deforming the reference projection surface 40 such that the reference projection surface 40 is along the asymptotic curve. The shape determination unit 30G generates an asymptotic curve of a plurality of detection points P predetermined toward a direction away from the detection point P closest to the self-position S of the moving object 2. A plurality of detection points P is required to be provided. For example, three or more detection points P are preferably provided. Furthermore, in this case, the shape determination unit 30G preferably generates an asymptotic curve of a plurality of detection points P at positions separated by a predetermined angle or more as viewed from the self-position S. For example, the shape determination unit 30G can determine, as the projection shape 41, a shape obtained by deforming the reference projection surface 40 such that the reference projection surface 40 is along the generated asymptotic curve Q in FIG. 5.

Note that the shape determination unit 30G may divide the periphery of the self-position S of the moving object 2 into respective specific ranges, and specify a detection point P closest to the moving object 2 or a plurality of detection points P in order of proximity to the moving object 2. Then, the shape determination unit 30G may determine, as the projection shape 41, a shape obtained by deforming the reference projection surface 40 such that the reference projection surface 40 passes through the detection point P specified for each range or is along the asymptotic curve Q of the plurality of detection points P.

Then, the shape determination unit 30G outputs projection shape information on the determined projection shape 41 to the deformation unit 32.

Next, one example of a flow of image processing, including distance stabilization processing, executed by the image processing apparatus 10 according to the first embodiment will be described.

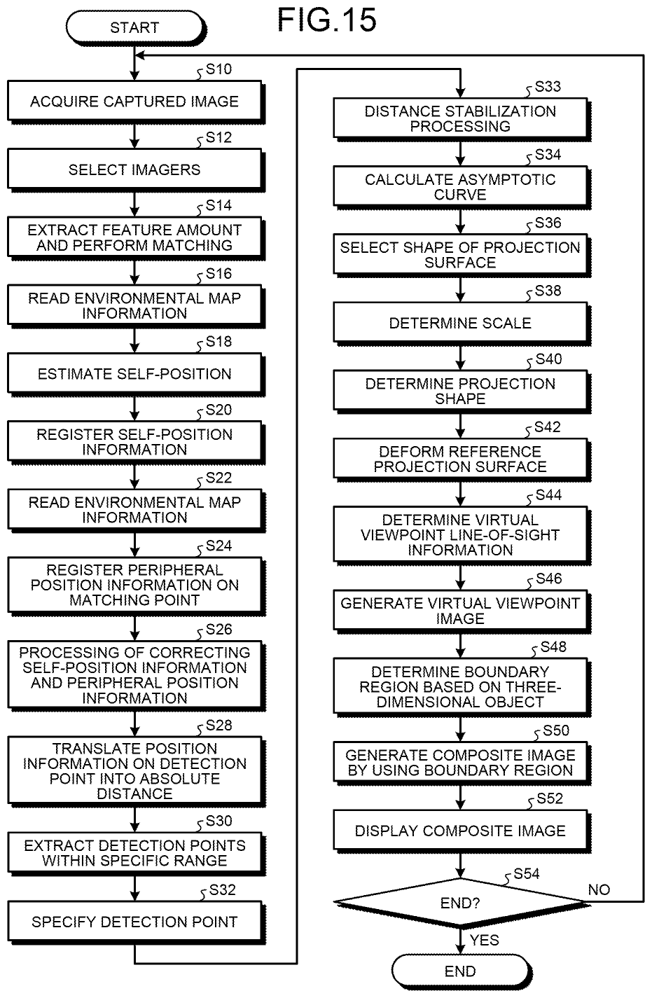

FIG. 15 is a flowchart illustrating one example of the flow of the image processing executed by the image processing apparatus 10.

The acquisition unit 20 acquires a captured image from the imager 12 (Step S10). Furthermore, the acquisition unit 20 captures a directly designated content (e.g., moving object 2 shifts into back gear) and a vehicle state (e.g., stop state).

The selector 23 selects at least two of the imagers 12A to 12D (Step S12).

The matching unit 25 extracts a feature amount and performs matching processing by using a plurality of captured images among the captured images acquired in Step S10 (Step S14). The plurality of captured images is captured by the imagers 12 selected in Step S12 at different imaging timings.

The self-position estimator 27 reads the environmental map information 26A (peripheral position information and self-position information) (Step S16). The self-position estimator 27 estimates a relative self-position with respect to the captured images by projective transformation or the like by using a plurality of matching points acquired from the matching unit 25 (Step S18), and registers the calculated self-position information in the environmental map information 26A (Step S20).

The three-dimensional restoration unit 29 reads the environmental map information 26A (peripheral position information and self-position information) (Step S22). The three-dimensional restoration unit 29 performs the perspective projection conversion processing by using an amount of movement (amount of translation and amount of rotation) of the self-position estimated by the self-position estimator 27, determines the three-dimensional coordinates of the matching points (relative coordinates with respect to self-position), and registers the three-dimensional coordinates in the environmental map information 26A as the peripheral position information (Step S24).

The corrector 28 reads the environmental map information 26A (peripheral position information and self-position information). The corrector 28 corrects the peripheral position information and the self-position information registered in the environmental map information 26A by using, for example, a least-squares method such that the total of differences of distances in the three-dimensional space between three-dimensional coordinates calculated in the past of one of points matched a plurality of times between a plurality of frames and newly calculated three-dimensional coordinates of one of the points is minimized (Step S26), and updates the environmental map information 26A.

The absolute distance translator 30A captures speed data on the moving object 2 (speed of moving object 2 itself) included in the CAN data received from the ECU 3 of the moving object 2. The absolute distance translator 30A translates the peripheral position information included in the environmental map information 26A into information on the distance from the current position, which is the latest self-position S of the moving object 2, to each of the plurality of detection points P by using the speed data on the moving object 2 (Step S28). The absolute distance translator 30A outputs the calculated distance information on each of the plurality of detection points P to the extractor 30B. Furthermore, the absolute distance translator 30A outputs the calculated current position of the moving object 2 to the virtual viewpoint line-of-sight determination unit 34 as the self-position information on the moving object 2.

The extractor 30B extracts a detection point P present within a specific range among the plurality of detection points P whose pieces of distance information have been received (Step S30).

The nearest neighbor specification unit 30C divides the periphery of the self-position S of the moving object 2 into respective specific ranges, specifies a detection point P closest to the moving object 2 or a plurality of detection points P in order of proximity to the moving object 2, and extracts the distance to a nearest neighbor object (Step S32). The nearest neighbor specification unit 30C outputs the measurement distance d of the detection point P specified for each range (measurement distance between moving object 2 and nearest neighbor object) to the distance stabilization processor 30I.

The distance stabilization processor 30I executes the first distance stabilization processing and the second distance stabilization processing by using the measurement distance d of the detection point P specified for each range as input, and outputs the stabilization distance D to the reference projection surface shape selector 30D, the scale determination unit 30E, the asymptotic curve calculator 30F, and the boundary region determination unit 30H (Step S33).

The asymptotic curve calculator 30F calculates an asymptotic curve (Step S34), and outputs the asymptotic curve to the shape determination unit 30G and the virtual viewpoint line-of-sight determination unit 34 as asymptotic curve information.

The reference projection surface shape selector 30D selects the shape of the reference projection surface 40 (Step S36), and outputs information on the selected shape of the reference projection surface 40 to the shape determination unit 30G.

The scale determination unit 30E determines the scale of the reference projection surface 40 having the shape selected by the reference projection surface shape selector 30D (Step S38), and outputs scale information on the determined scale to the shape determination unit 30G.

The shape determination unit 30G determines the projection shape as to how to deform the shape of the reference projection surface based on the scale information and the asymptotic curve information (Step S40). The shape determination unit 30G outputs projection shape information on the determined projection shape 41 to the deformation unit 32.

The deformation unit 32 deforms the shape of the reference projection surface based on the projection shape information (Step S42). The deformation unit 32 outputs information on the deformed projection surface to the projection converter 36.

The virtual viewpoint line-of-sight determination unit 34 determines virtual viewpoint line-of-sight information based on the self-position and the asymptotic curve information (Step S44). The virtual viewpoint line-of-sight determination unit 34 outputs the virtual viewpoint line-of-sight information indicating the virtual viewpoint O and the line-of-sight direction L to the projection converter 36.

The projection converter 36 generates a projection image obtained by projecting a captured image acquired from the imager 12 on the deformed projection surface based on the deformed projection surface information and the virtual viewpoint line-of-sight information. The projection converter 36 converts the generated projection image into a virtual viewpoint image (Step S46), and outputs the virtual viewpoint image to the image composition unit 38.

The boundary region determination unit 30H determines a boundary region based on the distance to the nearest neighbor object specified for each range. That is, the boundary region determination unit 30H determines the boundary region serving as an overlapping region of spatially adjacent peripheral images based on the position of the object located nearest to the moving object 2 (Step S48). The boundary region determination unit 30H outputs the determined boundary region to the image composition unit 38.

The image composition unit 38 generates a composite image by combining spatially adjacent perspective projection images using the boundary region (Step S50). That is, the image composition unit 38 generates a composite image by combining perspective projection images in four directions in accordance with the boundary region set to the angle in a nearest neighbor object direction. Note that, in the boundary region, the spatially adjacent perspective projection images are blended at a predetermined ratio.

The display 16 displays the composite image (Step S52).

The image processing apparatus 10 determines whether or not to end the image processing (Step S54). For example, the image processing apparatus 10 makes a determination of Step S54 by determining whether or not a signal indicating position movement stop of the moving object 2 has been received from the ECU 3. Furthermore, for example, the image processing apparatus 10 may make the determination of Step S54 by determining whether or not an instruction to end the image processing has been received by an operation instruction from the user and the like.

When a negative determination is made in Step S54 (Step S54: No), the above-described processing from Step S10 to Step S54 is repeatedly executed.

In contrast, when a positive determination is made in Step S54 (Step S54: Yes), the routine is ended.

Note that, when the processing returns from Step S54 to Step S10 after the correction processing of Step S26 is executed, the subsequent correction processing of Step S26 may be omitted. Furthermore, when the processing returns from Step S54 to Step S10 without executing the correction processing of Step S26, the subsequent correction processing of Step S26 may be executed.

As described above, the image processing apparatus 10 according to the embodiment includes the determination unit 30, which serves as a converter, and the deformation unit 32. The determination unit 30 converts the measurement distance between a three-dimensional object around the moving object 2 and the moving object 2 into the first distance or the second distance smaller than the first distance, which serves as the stabilization distance, based on the magnitude relation between the measurement distance and the first threshold. The deformation unit 32 deforms the projection surface of a peripheral image of the moving object 2 based on the stabilization distance.

Therefore, even when the measurement distance fluctuates including a slight increase amount or decrease amount in addition to a change amount with rearward traveling of the moving object 2, the measurement distance can be converted into a stabilization distance with less fluctuations. The deformation unit 32 deforms the projection surface of the peripheral image of the moving object 2 based on the stabilization distance with less fluctuations. As a result, the temporal fluctuation of the projection surface can be inhibited, and a problem that the projection image becomes unnatural can be solved.

Furthermore, the determination unit 30 converts the measurement distance into the second distance serving as the stabilization distance based on the magnitude relation between the measurement distance and the first threshold, and converts the measurement distance into the first distance serving as the stabilization distance based on the magnitude relation between the measurement distance and the second threshold larger than the first threshold.

Therefore, in a period corresponding to before and after switching of the stabilization distance, a phenomenon in which the projection surface fluctuates in conjunction with fluctuation of the stabilization distance is inhibited. As a result, a problem that the projection image becomes unnatural can be further solved.

Furthermore, when the measurement distance is smaller than the first threshold, the determination unit 30 converts the measurement distance into the second distance or the third distance smaller than the second distance, which serves as the stabilization distance, based on the magnitude relation between the measurement distance and the third threshold smaller than the first threshold. The deformation unit 32 deforms the projection surface of the peripheral image of the moving object 2 based on the second distance or the third distance obtained by converting the measurement distance.

Therefore, even after the measurement distance becomes smaller than the first threshold, the temporal fluctuation of the projection surface can be stably inhibited, and the problem that the projection image becomes unnatural can be solved.

First Variation

In the above-described embodiment, the image processing including the distance stabilization processing has been described in an example in which the moving object 2 approaches a three-dimensional object by rearward traveling (or rearward parking). In contrast, the image processing including similar distance stabilization processing can be applied to a case where the moving object 2 moves away from the three-dimensional object by forward traveling.

In such a case, the distance stabilization processor 30I converts the measurement distance d into the stabilization distance D₄ and outputs the stabilization distance D₄ until the measurement distance d gradually increasing from d₈ with the forward traveling of the moving object 2 exceeds the threshold d₆ as illustrated in FIG. 12, for example. In contrast, when the measurement distance d exceeds the threshold d₆, the distance stabilization processor 30I converts the measurement distance d into the stabilization distance D₃ and outputs the stabilization distance D₃.

Furthermore, as illustrated in FIG. 12, after the measurement distance d becomes larger than the threshold d₆ and the stabilization distance D has been converted into D₃, the distance stabilization processor 30I does not convert the stabilization distance D into D₄ until the measurement distance d becomes smaller than the threshold d₇ which is smaller than the threshold d₆.

Second Variation

In the above-described embodiment, at least one of space outlier removal processing, time outlier removal processing, space smoothing processing, and time smoothing processing may be executed on a measurement distance in the preceding stage of the distance stabilization processor 30I (e.g., immediately before determination unit 30). The distance stabilization processor 30I executes distance stabilization processing by using the measurement distance output from a preprocessor. Such a configuration can further improve accuracy.

Third Variation

In the above-described embodiment, the stabilization distance D may be gradually changed. For example, when the measurement distance d becomes smaller than the threshold d₃, the stabilization distance D may be gradually changed from D₁ to D₂. Furthermore, when the measurement distance d becomes larger than the threshold d2, the stabilization distance D may be gradually changed from D₂ to D₁. Such processing may also be applied to other stabilization distances.

### Second Embodiment

In the above-described first embodiment, an example of a mode in which position information (peripheral position information) on a detection point P is acquired from a captured image captured by the imager 12, that is, a mode in which Visual SLAM is used has been described. In contrast, in a second embodiment, an example of a mode in which the detector 14 detects the position information (peripheral position information) on the detection point P will be described. That is, the image processing apparatus 10 according to the second embodiment is an example in which three-dimensional LiDAR SLAM and the like are used.

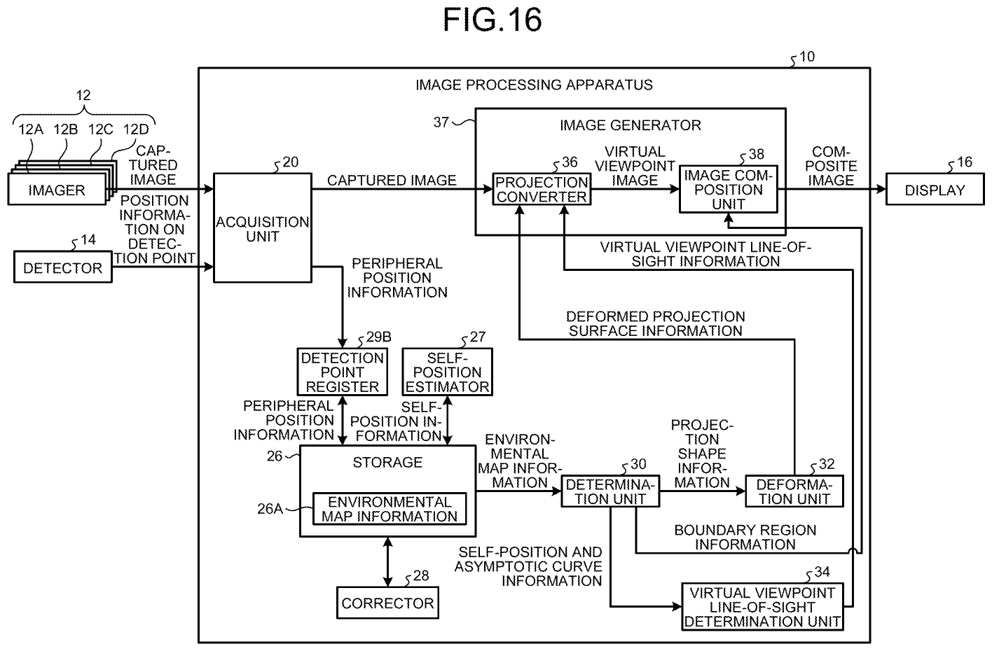

FIG. 16 illustrates one example of a functional configuration of the image processing apparatus 10 of the second embodiment. Similarly to the image processing apparatus 10 of the first embodiment, the image processing apparatus 10 is connected to the imager 12, the detector 14, and the display 16 so as to be able to transfer data or signals.

The image processing apparatus 10 includes the acquisition unit 20, the self-position estimator 27, a detection point register 29B, the storage 26, the corrector 28, the determination unit 30, the deformation unit 32, the virtual viewpoint line-of-sight determination unit 34, the projection converter 36, and the image composition unit 38.

Some or all of the plurality of above-described units may be implemented by causing a processing device such as the CPU 10A in FIG. 2 to execute a program, that is, by software, for example. Furthermore, some or all of the plurality of above-described units may be implemented by hardware such as an IC, or may be implemented by using software and hardware together.

In FIG. 16, the storage 26, the corrector 28, the determination unit 30, the deformation unit 32, the virtual viewpoint line-of-sight determination unit 34, the projection converter 36, and the image composition unit 38 are similar to those of the first embodiment. The storage 26 stores the environmental map information 26A. The environmental map information 26A is similar to that of the first embodiment.

The acquisition unit 20 acquires a captured image from the imager 12. Furthermore, the acquisition unit 20 acquires the peripheral position information from the detector 14. The acquisition unit 20 acquires a captured image from each of the imagers 12 (imagers 12A to 12D). The detector 14 detects the peripheral position information. Thus, the acquisition unit 20 acquires the peripheral position information and captured images from a plurality of respective imagers 12.

Each time the peripheral position information is acquired, the acquisition unit 20 outputs the acquired peripheral position information to the detection point register 29B. Furthermore, each time a captured image is acquired, the acquisition unit 20 outputs the acquired captured image to the projection converter 36.

Each time new peripheral position information is acquired from the detector 14, the detection point register 29B performs scan matching with the peripheral position information registered in the environmental map information 26A, determines a relative positional relation for adding the new peripheral position information to the registered peripheral position information, and then adds the new peripheral position information to the environmental map information 26A.

The corrector 28 corrects the peripheral position information registered in the environmental map information 26A by using, for example, a least-squares method such that the total of differences of distances in the three-dimensional space between three-dimensional coordinates calculated in the past of one of detection points matched a plurality of times by the scan matching and newly calculated three-dimensional coordinates of one of the detection points is minimized.

The self-position estimator 27 can calculate amounts of translation and rotation of the self-position from the positional relation between the peripheral position information registered in the environmental map information 26A and the newly added peripheral position information, and estimates the amounts as the self-position information.

As described above, in the embodiment, the image processing apparatus 10 updates the peripheral position information and estimates the self-position information on the moving object 2 simultaneously by the SLAM.

Next, one example of a flow of image processing, including distance stabilization processing, executed by the image processing apparatus 10 according to the second embodiment will be described.

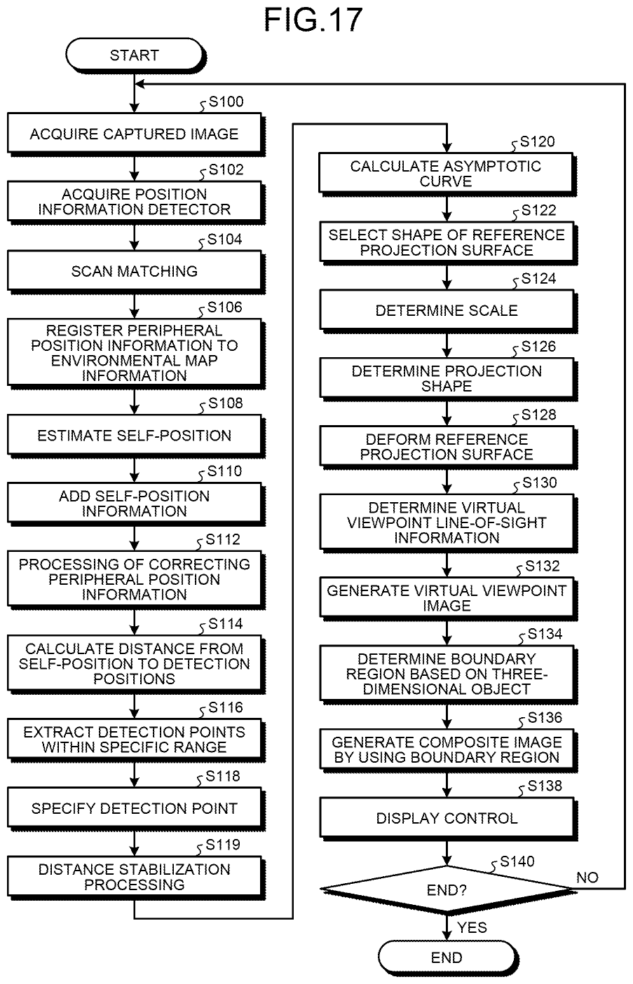

FIG. 17 is a flowchart illustrating one example of a flow of image processing executed by the image processing apparatus 10.

The acquisition unit 20 acquires a captured image from the imager 12 (Step S100). Furthermore, the acquisition unit 20 acquires the peripheral position information from the detector 14 (Step S102).

Each time new peripheral position information is acquired from the detector 14, the detection point register 29B performs scan matching with the peripheral position information registered in the environmental map information 26A (Step S104). Then, the detection point register 29B determines the relative positional relation for adding the new peripheral position information to the peripheral position information registered in the environmental map information 26A, and then adds the new peripheral position information to the environmental map information 26A (Step S106).

The self-position estimator 27 can calculate amounts of translation and rotation of the self-position from the positional relation between the peripheral position information registered in the environmental map information 26A and the newly added peripheral position information, and estimates the amounts as the self-position information (Step S108). Then, the self-position estimator 27 adds the self-position information to the environmental map information 26A (Step S110).

The corrector 28 corrects the peripheral position information registered in the environmental map information 26A by using, for example, a least-squares method such that the total of differences of distances in the three-dimensional space between three-dimensional coordinates calculated in the past of one of detection points matched a plurality of times by the scan matching and newly calculated three-dimensional coordinates of one of the detection points is minimized (Step S112), and updates the environmental map information 26A.

The absolute distance translator 30A of the determination unit 30 obtains information on distances from the current position of the moving object 2 to a plurality of peripheral detection points P based on the environmental map information 26A (Step S114).

The extractor 30B extracts detection points P present within a specific range among the detection points P whose distance information of the absolute distance has been calculated by the absolute distance translator 30A (Step S116).

The nearest neighbor specification unit 30C specifies a plurality of detection points P in order of proximity to the moving object 2 for each range around the moving object 2 by using the distance information on each of the detection points P extracted in Step S116 (Step S118).

The distance stabilization processor 30I executes the first distance stabilization processing and the second distance stabilization processing by using the measurement distance d of the detection point P specified for each range as input, and outputs the stabilization distance D to the reference projection surface shape selector 30D, the scale determination unit 30E, the asymptotic curve calculator 30F, and the boundary region determination unit 30H (Step S119).

The asymptotic curve calculator 30F calculates the asymptotic curve Q by using each of the pieces of distance information on the plurality of detection points P for each range specified in Step S118 (Step S120).

The reference projection surface shape selector 30D selects the shape of a reference projection surface 40 (Step S122). A mode in which the reference projection surface shape selector 30D selects a bowl-shaped reference projection surface 40 as described above will be described as one example.

The scale determination unit 30E determines the scale of the reference projection surface 40 having the shape selected in Step S122 (Step S124).

The shape determination unit 30G enlarges or reduces the reference projection surface 40 having the shape selected in Step S122 to the scale determined in Step S124. Then, the shape determination unit 30G deforms the enlarged or reduced reference projection surface 40 such that the reference projection surface 40 follows the asymptotic curve Q calculated in Step S120. The shape determination unit 30G determines the deformed shape as the projection shape 41 (Step S126).

The deformation unit 32 deforms the reference projection surface 40 into the projection shape 41 determined by the determination unit 30 (Step S128). In the deformation processing, the deformation unit 32 generates the deformed projection surface 42, which is the deformed reference projection surface 40.

The virtual viewpoint line-of-sight determination unit 34 determines virtual viewpoint line-of-sight information (Step S130). For example, the virtual viewpoint line-of-sight determination unit 34 determines the self-position S of the moving object 2 as the virtual viewpoint O, and determines the direction from the virtual viewpoint O toward the position of the vertex W of the asymptotic curve Q as the line-of-sight direction L. Specifically, the virtual viewpoint line-of-sight determination unit 34 is required to determine, as the line-of-sight direction L, a direction toward a vertex W of the asymptotic curve Q in one specific range among the asymptotic curves Q calculated for each range in Step S120.

The projection converter 36 projects the captured image acquired in Step S100 onto the deformed projection surface 42 generated in Step S128. Then, the projection converter 36 converts the projection image into the virtual viewpoint image, which is obtained by visually recognizing the captured image projected onto the deformed projection surface 42 from the virtual viewpoint O determined in Step S130 toward the line-of-sight direction L (Step S132).

The boundary region determination unit 30H determines a boundary region based on the distance to the nearest neighbor object specified for each range. That is, the boundary region determination unit 30H determines the boundary region serving as an overlapping region of spatially adjacent peripheral images based on the position of the object located nearest to the moving object 2 (Step S134). The boundary region determination unit 30H outputs the determined boundary region to the image composition unit 38.

The image composition unit 38 generates a composite image by combining spatially adjacent perspective projection images using the boundary region (Step S136). That is, the image composition unit 38 generates a composite image by combining perspective projection images in four directions in accordance with the boundary region set to the angle in a nearest neighbor object direction. Note that, in the boundary region, the spatially adjacent perspective projection images are blended at a predetermined ratio.

The display 16 executes display control of displaying a generated composite image 54 (Step S138).

Next, the image processing apparatus 10 determines whether or not to end the image processing (Step S140). For example, the image processing apparatus 10 makes a determination of Step S140 by determining whether or not a signal indicating position movement stop of the moving object 2 has been received from the ECU 3. Furthermore, for example, the image processing apparatus 10 may make the determination of Step S140 by determining whether or not an instruction to end the image processing has been received by an operation instruction from the user and the like.

When a negative determination is made in Step S140 (Step S140: No), the above-described processing from Step S100 to Step S140 is repeatedly executed. In contrast, when a positive determination is made in Step S140 (Step S140: Yes), the routine is ended.

Note that, when the processing returns from Step S140 to Step S100 after the correction processing of Step S112 is executed, the subsequent correction processing of Step S112 may be omitted. Furthermore, when the processing returns from Step S140 to Step S100 without executing the correction processing of Step S112, the subsequent correction processing of Step S112 may be executed.

As described above, the image processing apparatus 10 according to the second embodiment acquires the measurement distance between a three-dimensional object around the moving object 2 and the moving object 2 by the three-dimensional LiDAR SLAM processing. The determination unit 30 executes the first distance stabilization processing of converting a measurement distance into the first distance or the second distance smaller than the first distance, which serves as the stabilization distance, based on the magnitude relation between the acquired measurement distance and the first threshold. The deformation unit 32 deforms the projection surface of the peripheral image of the moving object 2 based on the first distance or the second distance obtained by converting the measurement distance. Therefore, functions and effects similar to those of the image processing apparatus 10 according to the first embodiment can be achieved by the image processing apparatus 10 according to the second embodiment.

Fourth Variation

In each of the above-described embodiments, the image processing apparatus 10 using the SLAM has been described. In contrast, image processing including the above-described distance stabilization processing can be executed by creating the environmental map information using an immediate value obtained by a sensor array and the like and using the environmental map information without using the SLAM. The sensor array is constructed by a distance sensor (millimeter wave radar and laser sensor), a sonar sensor, an ultrasonic sensor, and a plurality of distance sensors. The sonar sensor detects an object by sound waves.

Although the embodiments and the variations have been described above, the image processing apparatus, the image processing method, and the image processing program disclosed in the present application are not limited to the above-described embodiments and the like as they are. The image processing apparatus, the image processing method, and the image processing program can be embodied by deforming components without departing from the gist thereof in each implementation phase. Furthermore, various inventions can be formed by appropriately combining a plurality of components disclosed in each of the above-described embodiments and the like. For example, some components may be deleted from all the components in the embodiments.

Note that the above-described image processing apparatus 10 of the first embodiment and the second embodiment can be applied to various devices. For example, the above-described image processing apparatus 10 of the first embodiment and the second embodiment can be applied to a monitoring camera system, an in-vehicle system, or the like. The monitoring camera system processes a video obtained from a monitoring camera. The in-vehicle system processes an image of a peripheral environment outside a vehicle.

What is claimed is:

1. An image processing apparatus comprising:
a converter that converts a measurement distance between a three-dimensional object around a moving object and the moving object into a first distance or a second distance smaller than the first distance, which serves as a stabilization distance, based on magnitude relation between the measurement distance and a first threshold; and
a deformation unit that deforms a projection surface of a peripheral image of the moving object based on the stabilization distance.

2. The image processing apparatus according to claim 1,
wherein the converter converts the measurement distance into the second distance serving as the stabilization distance based on magnitude relation between the measurement distance and the first threshold, and converts the measurement distance into the first distance serving as the stabilization distance based on magnitude relation between the measurement distance and a second threshold larger than the first threshold.

3. The image processing apparatus according to claim 2,
wherein, when the measurement distance is smaller than the first threshold, the converter converts the measurement distance into the second distance or a third distance smaller than the second distance, which serves as the stabilization distance, based on magnitude relation between the measurement distance and a third threshold smaller than the first threshold.

4. The image processing apparatus according to claim 1, further comprising a preprocessor that executes at least one of space outlier removal processing, time outlier removal processing, space smoothing processing, and time smoothing processing,
wherein the converter converts the measurement distance into the stabilization distance by using the measurement distance output from the preprocessor.

5. The image processing apparatus according to claim 1, further comprising:
a SLAM processor that generates map information on a periphery of the moving object by using detection point position information in which a detection point corresponding to the three-dimensional object around the moving object is accumulated and self-position information on the moving object; and
a distance translator that calculates information on a distance between the three-dimensional object around the moving object and the moving object as the measurement distance based on the map information.

6. The image processing apparatus according to claim 5, further comprising an image generator that projects the peripheral image onto the projection surface deformed by the deformation unit,
wherein the SLAM processor executes visual simultaneous localization and mapping (SLAM) processing by using the peripheral image, and calculates the measurement distance.

7. An image processing method to be executed by a computer, comprising the steps of:
acquiring a measurement distance between a three-dimensional object around a moving object and the moving object;
converting the measurement distance into a first distance or a second distance smaller than the first distance, which serves as a stabilization distance, based on magnitude relation between the measurement distance and a first threshold; and
deforming a projection surface of a peripheral image of the moving object based on the stabilization distance.

8. An image processing computer program product causing a computer to execute the steps of:
acquiring a measurement distance between a three-dimensional object around a moving object and the moving object;
converting the measurement distance into a first distance or a second distance smaller than the first distance, which serves as a stabilization distance, based on magnitude relation between the measurement distance and a first threshold; and
deforming a projection surface of a peripheral image of the moving object based on the stabilization distance.
